(19) United States
(12) Patent Application Publication
(10) Pub. No.: US 2025/0037245 A1
(43) Pub. Date: Jan. 30, 2025

(54) JOINT NOISE REDUCTION FOR IN-PHASE AND QUADRATURE COMPONENTS OF AN INDIRECT TIME-OF-FLIGHT SENSOR

(71) Applicant: QUALCOMM Incorporated, San Diego, CA (US)

(72) Inventors: Li Hong, San Diego, CA (US); Jing Wang, Saratoga, CA (US); Xiaoyun Jiang, San Diego, CA (US)

(21) Appl. No.: 18/358,666

(22) Filed: Jul. 25, 2023

(51) Int. Cl. G06T 5/00; G01S 17/46; G06T 5/20; G06T 7/246

(52) U.S. Cl. CPC G06T 5/70; G01S 17/46; G06T 5/20; G06T 7/248; G06T 2207/10028; G06T 2207/20028

(57) ABSTRACT

An apparatus configured for sensor processing is configured to receive a current frame of raw data from an indirect ToF sensor, wherein the raw data comprises an in-phase component and a quadrature component for each pixel of the current frame. The apparatus may jointly apply a first spatial noise reduction filter to the in-phase components and the quadrature components of the current frame, jointly apply, after the first spatial noise reduction filter, a temporal filter to the in-phase components and the quadrature components of the current frame, and jointly apply, after the temporal filter, a second spatial noise reduction filter to the in-phase components and the quadrature components of the current frame to produce a filtered current frame. The apparatus may then output the filtered current frame and use the filtered current frame to determine depth value for other applications.

### TECHNICAL FIELD

This disclosure relates to noise reduction for indirect time-of-flight sensors.

### BACKGROUND

An indirect time-of-flight (ToF) sensor is a type of sensor that measures the time it takes for light or other signals to travel from the sensor to an object and back. Unlike direct ToF sensors that emit and receive light directly, indirect ToF sensors rely on external light sources such as ambient light or lasers to measure the time-of-flight. Indirect ToF sensors typically use specialized detectors to capture the reflected or scattered light and calculate the distance based on the time and/or phase delay. Indirect ToF sensors can be used in various applications, such as distance and depth estimation, proximity sensing, gesture recognition, object tracking, and 3D mapping. ToF sensors are commonly found in consumer electronics, robotics, automotive safety systems, and augmented reality devices.

One example use of an indirect ToF sensor is in smartphones for depth sensing in portrait photography and augmented reality applications. By measuring phase differences for reflected light, the sensor can calculate depth information, allowing for realistic background blur effects in photos or precise placement of virtual objects in artificial reality (AR) environments. Another application is in automotive safety systems, where indirect ToF sensors can be used for collision avoidance and adaptive cruise control. These sensors help vehicles detect the distance to surrounding objects and adjust the speed accordingly to maintain a safe driving distance.

### SUMMARY

In general, this disclosure describes techniques for reducing the noise in the output of an indirect ToF sensor. In particular, this disclosure describes noise reduction techniques where the in-phase and quadrature components of the raw output of an indirect ToF sensor are filtered jointly. The filtering techniques of this disclosure include combining both in-phase and quadrature components to determine denoise filter weights and strengths. The in-phase and quadrature components may be jointly filtered in both the spatial domain and the temporal domain. In some examples, the denoising process may include a first joint spatial filter, followed by a joint temporal filter, followed by a second joint temporal filter.

In addition, the techniques of this disclosure may include bad pixel detection and correction, peak noise reduction, and data decompanding. By applying the filtering techniques of this disclosure to the in-phase and quadrature components jointly, as opposed to separately, the relationship between the in-phase and quadrature components is maintained. As such, more accurate depth calculation may be made from the denoised data.

In one example, this disclosure describes an apparatus configured for sensor processing, the apparatus comprising a memory, and one or more processors coupled to the memory. The one or more processors configured to cause the apparatus to receive a current frame of raw data from an indirect ToF sensor, wherein the raw data comprises an in-phase component and a quadrature component for each pixel of the current frame, jointly apply a first spatial noise reduction filter to the in-phase components and the quadrature components of the current frame, jointly apply, after the first spatial noise reduction filter, a temporal filter to the in-phase components and the quadrature components of the current frame, jointly apply, after the temporal filter, a second spatial noise reduction filter to the in-phase components and the quadrature components of the current frame to produce a filtered current frame, and output the filtered current frame.

In another example, this disclosure describes a method for sensor processing the method comprising receiving a current frame of raw data from an indirect ToF sensor, wherein the raw data comprises an in-phase component and a quadrature component for each pixel of the current frame, jointly applying a first spatial noise reduction filter to the in-phase components and the quadrature components of the current frame, jointly applying, after the first spatial noise reduction filter, a temporal filter to the in-phase components and the quadrature components of the current frame, jointly applying, after the temporal filter, a second spatial noise reduction filter to the in-phase components and the quadrature components of the current frame to produce a filtered current frame, and outputting the filtered current frame.

In another example, this disclosure describes an apparatus for sensor processing the apparatus comprising means for receiving a current frame of raw data from an indirect ToF sensor, wherein the raw data comprises an in-phase component and a quadrature component for each pixel of the current frame, means for jointly applying a first spatial noise reduction filter to the in-phase components and the quadrature components of the current frame, means for jointly applying, after the first spatial noise reduction filter, a temporal filter to the in-phase components and the quadrature components of the current frame, means for jointly applying, after the temporal filter, a second spatial noise reduction filter to the in-phase components and the quadrature components of the current frame to produce a filtered current frame, and means for outputting the filtered current frame.

In another example, this disclosure describes a non-transitory computer-readable storage medium storing instructions that, when executed, causes one or more processors configured for sensor processing to receive a current frame of raw data from an indirect ToF sensor, wherein the raw data comprises an in-phase component and a quadrature component for each pixel of the current frame, jointly apply a first spatial noise reduction filter to the in-phase components and the quadrature components of the current frame, jointly apply, after the first spatial noise reduction filter, a temporal filter to the in-phase components and the quadrature components of the current frame, jointly apply, after the temporal filter, a second spatial noise reduction filter to the in-phase components and the quadrature components of the current frame to produce a filtered current frame, and output the filtered current frame.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram of a device configured to perform noise reduction in the output of a ToF sensor according to the techniques of this disclosure.

FIG. 2 is a block diagram illustrating one example use case for the noise reduced output of a ToF sensor according to the techniques of this disclosure.

FIG. 3 is a block diagram showing one example of a noise reduction unit according to the techniques of this disclosure.

FIG. 4 is a block diagram showing one example of a first spatial noise reduction filter according to the techniques of this disclosure.

FIG. 5 is a conceptual diagram showing one example of a median calculation according to the techniques of this disclosure.

FIG. 6 is a conceptual diagram showing examples of bad pixel correction according to the techniques of this disclosure.

FIG. 7 is a conceptual diagram showing one example of cold pixel and hot pixel determination according to the techniques of this disclosure.

FIG. 8 is a block diagram showing one example of an adjustment process according to the techniques of this disclosure.

FIG. 9 is a block diagram showing one example of a temporal filter according to the techniques of this disclosure.

FIG. 10 is a flowchart showing an example method of operation according to the techniques of this disclosure.

### DETAILED DESCRIPTION

An indirect ToF sensor (also called an indirect ToF camera or ITOF sensor/camera) is a type of depth sensor used to measure the distance between the sensor and an object in its field of view. Unlike direct ToF sensors that emit a pulse of light and measure the time it takes for the reflected light to return, indirect ToF sensors rely on a phase shift principle to calculate distance. An indirect ToF sensor emits a modulated light signal (e.g., infrared) and captures the light reflected from objects in the scene. The indirect ToF sensor measures the phase difference between the emitted and received light signals. By comparing the phase shift with the known modulation frequency, the indirect ToF sensor can determine the distance to the object.

Indirect ToF sensors find applications in various fields, including smartphones, augmented reality (AR), robotics and automotive. Indirect ToF sensors are commonly used in robotics for obstacle detection and navigation. Indirect ToF sensors can be found in mobile devices for depth sensing in augmented reality AR applications or for implementing facial recognition. Indirect ToF sensors have applications in automotive systems for driver-assistance features, such as adaptive cruise control and collision avoidance.

In some examples, the output of indirect ToF sensors may be degraded by various noise sources, including thermal noise, reset noise, dark current noise, noise due to quantization, fixed pattern noise, and photo shot noise. Such degradation in the output of an indirect ToF sensor may lead to lowered accuracy in depth calculations made from the degraded output. Performing noise reduction techniques on depth data output from ToF sensors provides limited benefits. This is because depth data from indirect ToF sensors is calculated from the raw data output by the ToF sensor. Noise in the raw data degrades depth smoothness and accuracy.

This disclosure describes techniques for performing noise reduction on the raw data output by an indirect ToF sensor. Improving the quality of the raw data may then improve the accuracy of depth data calculated from the raw data. In some examples, this disclosure describes noise reduction techniques where the in-phase and quadrature components of the raw output of an indirect ToF sensor are processed jointly. The filtering techniques of this disclosure include combining both in-phase and quadrature components to determine denoise filter weights and strengths. The in-phase and quadrature components may be jointly filtered in both the spatial domain and the temporal domain. In some examples, the denoising process may include a first joint spatial filter, followed by a joint temporal filter, followed by a second joint temporal filter.

In addition, the techniques of this disclosure may include pre-processing before applying the joint spatial filter, where the pre-processing includes bad pixel detection and correction and shot noise reduction. The techniques of this disclosure may also include data decompanding on the filtered output in the situation where the indirect ToF sensor output is in a companded format.

By applying the filtering techniques of this disclosure to the in-phase and quadrature components jointly, as opposed to separately, the relationship between the in-phase and quadrature components are maintained. That is, because the same filter weights and strengths are used for both in-phase and quadrature components, the relationship between the two components is maintained, thus resulting in more accurate depth values. If denoising is applied to the in-phase and quadrature components separately, the separate denoising processes may alter the relationship between the two components, which may lead to inaccurate depth measurements. As such, the techniques of this disclosure may lead to more accurate depth calculations compared to other denoising techniques for indirect ToF sensors.

In one example, this disclosure describes an apparatus configured for sensor processing, the apparatus comprising a memory, and one or more processors coupled to the memory. The one or more processors are configured to cause the apparatus to receive a current frame of raw data from an indirect ToF sensor, wherein the raw data comprises an in-phase component and a quadrature component for each pixel of the current frame. The one or more processors may cause the apparatus to jointly apply a first spatial noise reduction filter to the in-phase components and the quadrature components of the current frame, jointly apply, after the first spatial noise reduction filter, a temporal filter to the in-phase components and the quadrature components of the current frame, and jointly apply, after the temporal filter, a second spatial noise reduction filter to the in-phase components and the quadrature components of the current frame to produce a filtered current frame. The apparatus may then output the filtered current frame and use the filtered current frame to determine depth value for other applications.

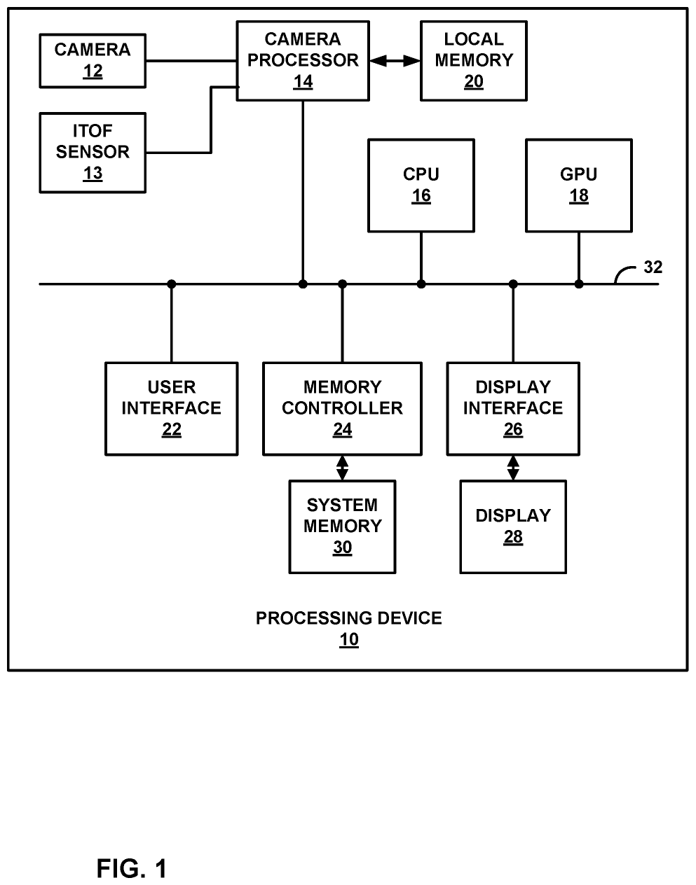

FIG. 1 is a block diagram of a processing device 10 configured to perform one or more of the example techniques for noise reduction in an indirect ToF sensor described in this disclosure. Examples of processing device 10 include processing systems in an automobile (e.g., an advance driver assistance system (ADAS)), processing systems in a robotics application, AR headsets, virtual reality (VR) headsets, stand-alone digital cameras or digital video camcorders, camera-equipped wireless communication device handsets, such as mobile telephones having one or more cameras, cellular or satellite radio telephones, camera-equipped personal digital assistants (PDAs), computing panels or tablets, gaming devices, computer devices that include cameras, such as so-called “web-cams,” or any device with digital imaging or video capabilities.

As illustrated in the example of FIG. 1, processing device 10 includes camera 12 (e.g., having an image sensor and lens), indirect ToF (ITOF) sensor 13, camera processor 14 and local memory 20 of camera processor 14, a central processing unit (CPU) 16, a graphical processing unit (GPU) 18, user interface 22, memory controller 24 that provides access to system memory 30, and display interface 26 that outputs signals that cause graphical data to be displayed on display 28. Although the example of FIG. 1 illustrates processing device 10 including one camera 12, in some examples, processing device 10 may include a plurality of cameras 12, such as for omnidirectional image or video capture. Also, although processing device 10 is illustrated as including one camera processor 14, in some examples, there may be a plurality of camera processors (e.g., one for each of cameras 12) or one camera processor for each of one or more cameras 12 and another camera processor for ITOF sensor 13.

Also, although the various components are illustrated as separate components, in some examples the components may be combined to form a system on chip (SoC). As an example, camera processor 14, CPU 16, GPU 18, and display interface 26 may be formed on a common integrated circuit (IC) chip. In some examples, one or more of camera processor 14, CPU 16, GPU 18, and display interface 26 may be in separate IC chips. Additional examples of components that may be configured to perform the example techniques include a digital signal processor (DSP). Various other permutations and combinations are possible, and the techniques should not be considered limited to the example illustrated in FIG. 1.

The various components illustrated in FIG. 1 (whether formed on one device or different devices) may be formed as at least one of fixed-function or programmable circuitry such as in one or more microprocessors, application specific integrated circuits (ASICs), field programmable gate arrays (FPGAs), digital signal processors (DSPs), or other equivalent integrated or discrete logic circuitry. Examples of local memory 20 and system memory 30 include one or more volatile or non-volatile memories or storage devices, such as random access memory (RAM), static RAM (SRAM), dynamic RAM (DRAM), erasable programmable ROM (EPROM), electrically erasable programmable ROM (EEPROM), flash memory, a magnetic data media or an optical storage media.

The various units illustrated in FIG. 1 communicate with each other using bus 32. Bus 32 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced extensible Interface (AXI) bus) or another type of bus or device interconnect. The specific configuration of buses and communication interfaces between the different components shown in FIG. 1 is merely exemplary, and other configurations of camera devices and/or other image processing systems with the same or different components may be used to implement the techniques of this disclosure.

Camera processor 14 is configured to receive image frames from camera 12, and process the image frames to generate output frames for display. CPU 16, GPU 18, camera processor 14, or some other circuitry may be configured to process the output frame that includes image content generated by camera processor 14 into images for display on display 28. In some examples, GPU 18 may be further configured to render graphics content on display 28.

In some examples, camera processor 14 may be configured as an image processing pipeline. For instance, camera processor 14 may include a camera interface that interfaces between camera 12 and camera processor 14. Camera processor 14 may include additional circuitry to process the image content. Camera processor 14 outputs the resulting frames with image content (e.g., pixel values for each of the image pixels) to system memory 30 via memory controller 24.

CPU 16 may comprise a general-purpose or a special-purpose processor that controls operation of processing device 10. A user may provide input to processing device 10 to cause CPU 16 to execute one or more software applications. The software applications that execute on CPU 16 may include, for example, a media player application, a video game application, a graphical user interface application or another program. The user may provide input to processing device 10 via one or more input devices (not shown) such as a keyboard, a mouse, a microphone, a touch pad or another input device that is coupled to processing device 10 via user interface 22.

Memory controller 24 facilitates the transfer of data going into and out of system memory 30. For example, memory controller 24 may receive memory read and write commands, and service such commands with respect to memory 30 in order to provide memory services for the components in processing device 10. Memory controller 24 is communicatively coupled to system memory 30. Although memory controller 24 is illustrated in the example of processing device 10 of FIG. 1 as being a processing circuit that is separate from both CPU 16 and system memory 30, in other examples, some or all of the functionality of memory controller 24 may be implemented on one or both of CPU 16 and system memory 30.

System memory 30 may store program modules and/or instructions and/or data that are accessible by camera processor 14, CPU 16, and GPU 18. For example, system memory 30 may store user applications, resulting frames from camera processor 14, etc. System memory 30 may additionally store information for use by and/or generated by other components of processing device 10. For example, system memory 30 may act as a device memory for camera processor 14.

Processing device 10 may further include ITOF sensor 13. In other contexts, ITOF sensor 13 may be referred to as an ITOF camera, a time-of-flight camera, a phase shift depth sensor, a modulated light depth sensor, and/or an optical depth sensor. In general, ITOF sensor 13 is a type of depth sensor used to measure the distance between the sensor and an object in its field of view. Unlike direct ToF sensors that emit a pulse of light and measure the time it takes for the reflected light to return, ITOF sensor 13 may operate on a phase shift principle to calculate distance. ITOF sensor 13 may emit a modulated light signal (e.g., infrared) and capture the light reflected from objects in the scene.

ITOF sensor 13 may include an emitter that produces a modulated light signal and a receiver that detects the reflected light. ITOF sensor 13 may also include a microcontroller or a dedicated signal processing unit to calculate the phase difference and convert the phase difference into distance measurements. The emitter and receiver are typically placed side by side or in close proximity to each other on the sensor module. When the emitter emits the modulated light signal, the modulated light signal travels through the scene and reflects off objects. The receiver captures the reflected light, which contains the modulated signal with a phase shift. By analyzing the phase shift, ITOF sensor 13 can determine the time it takes for the light to travel back and forth. This information is used to calculate the distance between the sensor and the object based on the speed of light.

In some examples, rather than outputting calculated depth information, ITOF sensor 13 may output data for a frame in the raw domain (also called raw data). The raw domain of ITOF sensor 13 refers to the original (e.g., raw) data captured by the sensor before any processing or manipulation is applied (e.g., depth calculations). In the case of an indirect ToF sensor, the raw domain typically represents the measurements of phase shift or other relevant parameters associated with the detected modulated light signal. The exact nature of the raw domain data (or simply raw data) can vary depending on the specific implementation of the sensor and the associated signal processing algorithms of the sensor. However, in general, the raw domain data of an indirect ToF sensor consists of numerical values that reflect the measured phase shift or other relevant information obtained from the reflected light signal.

In one example, the raw data of a frame (e.g., raw domain) output of ITOF sensor 13 is represented by a complex number that includes a real component (e.g., an in-phase (I) component) and an imaginary component (e.g., a quadrature (Q) component). That is, each pixel of the ITOF sensor 13 may output an (I,Q) value. The in-phase and quadrature components are two fundamental components that are derived from the measured phase shift of the modulated light signal. These in-phase and quadrature components may be used in subsequent calculations to determine the distance or depth information.

The in-phase component, often denoted as I or Re, represents the real component of the measured phase shift. The in-phase component indicates the amount of displacement or phase shift in the same direction as the reference signal. In other words, the in-phase component corresponds to the portion of the phase shift that aligns with the reference signal's phase.

The quadrature component, often denoted as Q or Im, represents the imaginary component of the measured phase shift. The quadrature component indicates the amount of displacement or phase shift perpendicular or orthogonal to the reference signal. The quadrature component corresponds to the portion of the phase shift that is 90 degrees out of phase with the reference signal.

In some examples, ITOF sensor 13 may be configured to obtain the in-phase and quadrature components through mathematical operations applied to the raw phase shift data that is captured. Such operations may involve demodulation techniques, such as phase demodulation or Fourier analysis, to separate the phase shift into its respective components. Once the in-phase and quadrature components are determined, the in-phase and quadrature components are typically used in further calculations to derive the distance or depth information. The combination of the in-phase and quadrature components enables the calculation of the magnitude and angle of the phase shift, which can then be related to the time of flight and converted into distance measurements using appropriate calibration and mathematical models.

In some examples, the output (in both the raw domain as well as calculated distances and/or depth information) of ITOF sensor 13 may be degraded by various noise sources, including thermal noise, reset noise, dark current noise, noise due to quantization, fixed pattern noise, and photo shot noise. Such degradation in the output of ITOF sensor 13 may lead to lowered accuracy in depth calculations made from the degraded output. Performing noise reduction techniques on depth data output from ITOF sensor 13 provides limited benefits. This is because depth data from ITOF sensor 13 is calculated from the raw data output by ITOF sensor 13. Noise in the raw data degrades depth smoothness and accuracy.

This disclosure describes techniques for performing noise reduction on the raw data output by ITOF sensor 13. Improving the quality of the raw data may then improve the accuracy of depth data calculated from the raw data. In some examples, this disclosure describes noise reduction techniques where the in-phase and quadrature components of the raw output from ITOF sensor 13 are processed jointly. The filtering techniques of this disclosure include combining both in-phase and quadrature components to determine denoise filter weights and strengths. The in-phase and quadrature components may be jointly filtered in both the spatial domain and the temporal domain. In some examples, the denoising process may include a first joint spatial filter, followed by a joint temporal filter, followed by a second joint temporal filter.

In addition, the techniques of this disclosure may include bad pixel detection and correction, peak noise reduction, and data decompanding. By applying the filtering techniques of this disclosure to the in-phase and quadrature components jointly, as opposed to separately, the relationship between the in-phase and quadrature components are maintained. If denoising is applied to the in-phase and quadrature components separately, the separate denoising processes may alter the relationship between the two components, which may lead to inaccurate depth measurements. As such, the techniques of this disclosure may lead to more accurate depth calculations compared to other denoising techniques for ITOF sensor 13.

The noise reduction techniques of this disclosure may be performed by any combination of hardware, software, or firmware operating on one or more processors of processing device 10. That is, any combination of CPUs, GPUs, DPS, or camera processors may be configured to perform the techniques of this disclosure. The examples below will be described with reference to camera processor 14, but it should be understood that multiple different processors may work separately or jointly to perform any combination of techniques described herein.

In one example of the disclosure, as will be described in more detail below, camera processor 14 may be configured to receive a current frame of raw data from ITOF sensor 13, wherein the raw data comprises an in-phase component and a quadrature component for each pixel of the current frame. Camera processor 14 may jointly apply a first spatial noise reduction filter to the in-phase components and the quadrature components of the current frame. Camera processor 14 may also jointly apply, after the first spatial noise reduction filter, a temporal filter to the in-phase components and the quadrature components of the current frame. Camera processor 14 may further jointly apply, after the temporal filter, a second spatial noise reduction filter to the in-phase components and the quadrature components of the current frame to produce a filtered current frame. Camera processor 14 may then output the filtered current frame.

The output filtered current frame, in raw domain format, may then be used by camera processor 14, CPU 16, or another processor to determine depth values for the frame. Such depth values may then be used in any application that may utilize depth values. Some example use cases for the depth value determined from the output of ITOF sensor 13 may include camera special effect (e.g., Bokeh effects), camera auto focus for challenging scenes (e.g., low light, back light, etc.), face authentication, AR head mounted devices, 3D reconstruction, object detection, image segmentation, autonomous driving, distance measurement, and obstacle detection. For example, CPU 16, GPU 18, or another processor may use the output of ITOF sensor 13 (e.g., executing software application) to perform another task using the depth information.

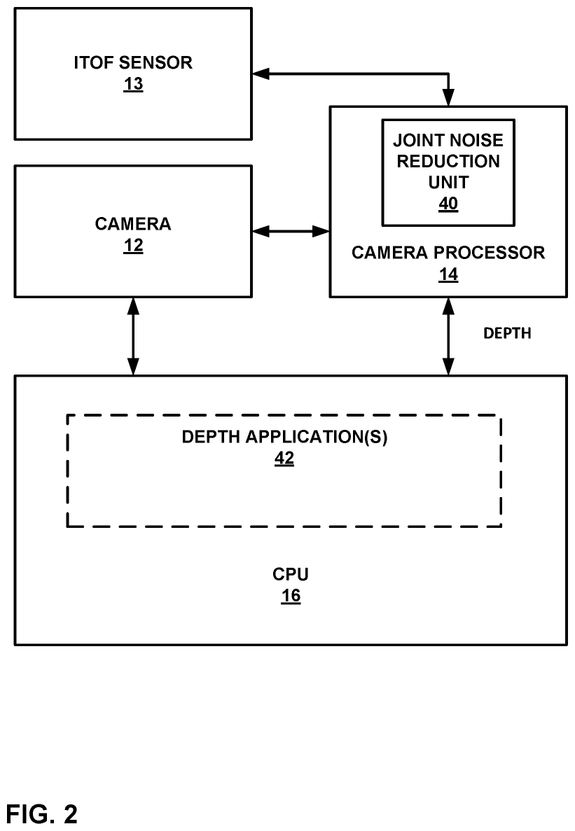

FIG. 2 is a block diagram illustrating one example use case for the noise reduced output of ITOF sensor 13 according to the techniques of this disclosure. In FIG. 2, camera processor 14 include a joint noise reduction unit 40 that takes raw data (e.g., in (I,Q) format) from ITOF sensor 13. Joint noise reduction unit 40 may be configured to perform the noise reduction features of this disclosure. Again, performing the noise reduction in camera processor 14 is just one example. In other examples, CPU 16 may perform the noise reduction features. In other examples, a combination of processors may perform the noise reduction features of this disclosure.

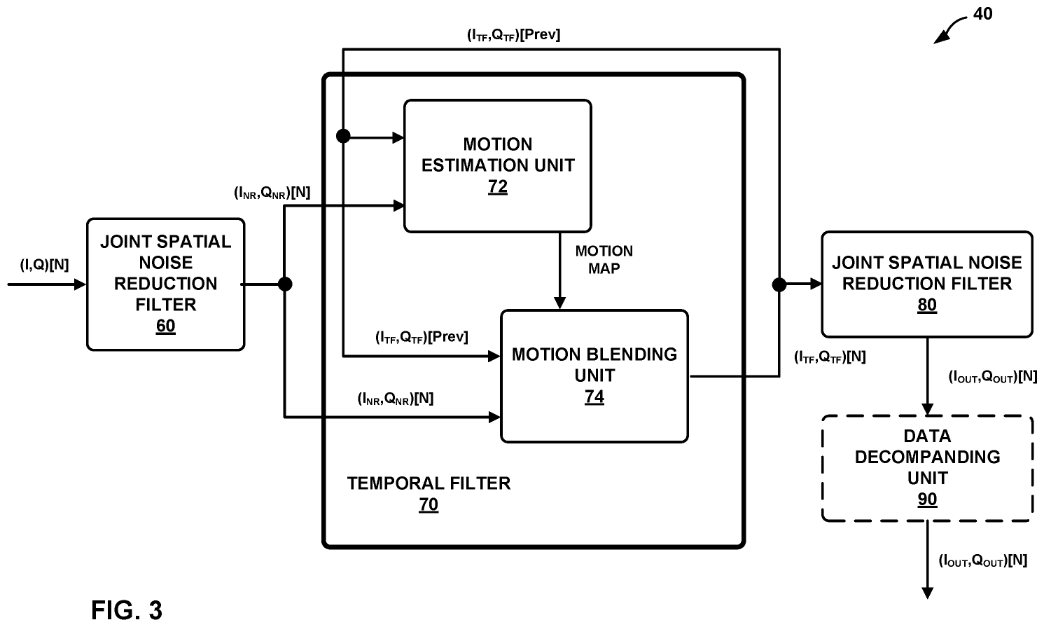

Joint noise reduction unit 40 may take as input a current frame of raw data of ITOF sensor 13, wherein the raw data include in-phase and quadrature components for each pixel of the current frame. Joint noise reduction unit 40 then may perform filtering techniques on the in-phase and quadrature components jointly, including both joint spatial filtering and joint temporal filtering. Details on the operation of joint noise reduction unit 40 will be described in more detail below with reference to FIGS. 3-9.

Camera processor 14 may further calculate depth information from the noise reduced raw data produced by joint noise reduction unit 40. Camera processor 14 may also be configured to process images received from camera 12. CPU 16 may receive the depth information from camera processor 14 and use such depth information in any number of depth application(s) 42. For example, CPU 16 may use the depth information to determine the location and type of objects in an image captured by camera 12.

FIG. 3 is a block diagram showing one example of joint noise reduction unit 40 according to the techniques of this disclosure. At a high level, joint noise reduction unit 40 may include a joint spatial noise reduction filter 60, a temporal filter 70, a joint spatial noise reduction filter 80. While the techniques below may are described such that each of joint spatial noise reduction filter 60, a temporal filter 70, a joint spatial noise reduction filter 80 are applied, in other techniques only a subset of these three filters may be applied. That is, each of joint spatial noise reduction filter 60, a temporal filter 70, a joint spatial noise reduction filter 80 may be controlled by an enable/disable bit, such that each of the three filters may be selectively applied to a frame in any combination. Furthermore, joint noise reduction unit 40 may optionally further include a data decompanding unit 90.

Joint noise reduction unit 40 may receive a current frame of raw data (I,Q)[N] from ITOF sensor 13. Here, I represents the in-phase components of each pixel of frame N and Q represents the corresponding quadrature components of each pixel of frame N. In some examples, current frame of raw data (I,Q)[N] may be in a companded format. For higher raw data bits (e.g., due to high dynamic range (HDR) or high precision concerns), ITOF sensor 13 may compand the raw output before sending to joint noise reduction unit 40 in order to reduce the total number of bits.

In general, data companding, also known as compression and expansion, involves reducing the dynamic range of a signal by compressing the signal before transmission or storage. The purpose of companding is to allocate more bits to represent the portions (e.g., value ranges) of the signal that typically include more information and fewer bits to represent the portions of the signal that typically includes less information. Companding may help to optimize bandwidth usage and minimize quantization errors.

Typically, data companding may include the application of a piecewise linear function to the input data. The companding algorithm assigns finer quantization levels to some ranges of the data, thus providing higher resolution, while providing coarser quantization levels to other ranges of the data, thus providing lower resolution. As one example, current frame of raw data (I,Q)[N] may be companded to a target number of bits by ITOF sensor 13 (e.g., 16 bits).

Regardless of whether the input raw data is companded or not, joint spatial noise reduction filter 60 performs a joint spatial noise reduction process on both I and Q components of the frame. Joint spatial noise reduction filter 60 may also perform pre-processing on the current frame of raw data (I,Q)[N] to perform bad pixel correction and shot noise reduction. The output of joint spatial noise reduction filter 60 is a noise reduced (NR) current frame of raw data (I_{NR},Q_{NR})[N].

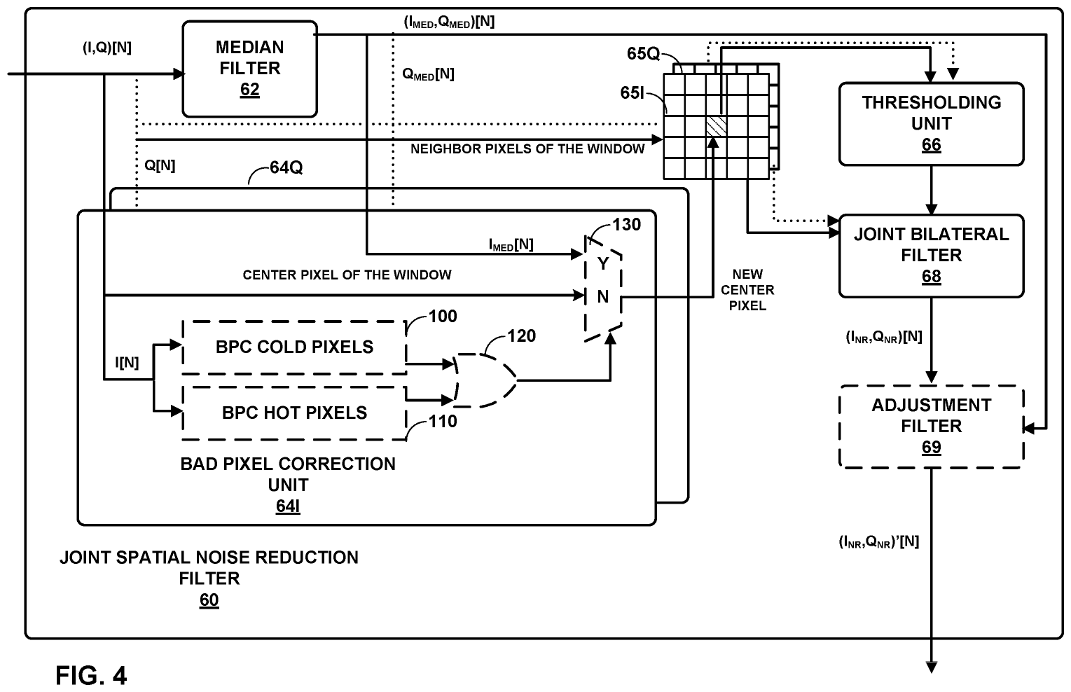

FIG. 4 is a block diagram showing one example of joint spatial noise reduction filter 60 in more detail. Joint spatial noise reduction filter 60 include a median filter 62, a bad pixel correction unit 64I (e.g., for in-phase components), a bad pixel correction unit 64Q (e.g., for quadrature components), a thresholding unit 66, a joint bilateral filter 68, and adjustment filter 69. In general, joint spatial noise reduction filter 60 removes spatial noise in the raw (I.Q) inputs. Joint spatial noise reduction filter 60 may be configured as a non-linear, edge-preserving, and noise-reducing smoothing filter with some conditions. Joint bilateral filter 68 functions as a main smoothing filtering. Median filter 62 and bad pixel correction units 64I and 64Q are optional functions for further pixel correction and noise reduction.

Median filter 62 takes the current frame of raw data (I,Q)[N] as input and produces a median value (I_{MED},Q_{MED})[N] for each of the in-phase and quadrature components for each pixel in the frame. The output of median filter 62 may be used by bad pixel correction units 64I and 64Q to replace the in-phase and quadrature values, respectively, of detected bad pixels. In addition, the output of median filter 62 may also be used by adjustment filter 69 for further filtering to improve edge smoothness.

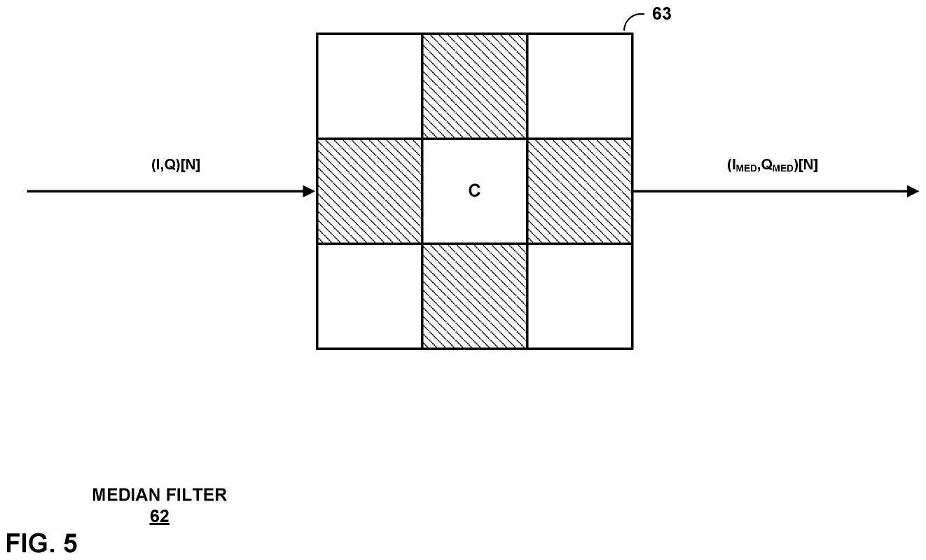

FIG. 5 is a conceptual diagram showing one example of a median calculation performed by median filter 62. Median filter 62 may receive a 3×3 grid 63 of in-phase and quadrature components from the current frame (e.g., (I,Q)[N]). 3×3 grid 63 is just one example grid size. In other examples, median filter 62 may use a larger grid. For each of the in-phase components and quadrature components, median filter 62 may calculate a median value of the in-phase and quadrature components, respectively, of the neighboring pixels in 3×3 grid 63 that surround center pixel c. A median value is calculated and output for each component of each pixel. This output is shown as (I_{MED},Q_{MED})[N].

In the example of FIG. 5, rather than using every component value in 3×3 grid, only the shaded pixels directly above, below, to the left, and to the right of center pixel c are used in the median calculation. In other examples, other patterns or numbers of component values of neighboring pixels may be used.

Returning to FIG. 4, joint noise reduction filter may include bad pixel correction (BPC) unit 64I and bad pixel correction unit 64Q. Bad pixel correction unit 64I is generally configured to detect bad pixels in a particular window of current frame of raw data (I,Q)[N]. For example, bad pixel correction unit 64I may operate on a 5×5 window of in-phase component values I[N] of current frame of raw data (I,Q)[N]. Bad pixel correction unit 64I may identify whether or not a center pixel of the window is bad (e.g., is a hot pixel, or is a cold pixel), and then replace the bad pixel with another value (e.g., a median value produced by median filter 62). While not shown completely, bad pixel correction unit 64Q is identical to bad pixel correction unit 64I, but operates on windows (e.g., 5×5 windows) of quadrature component values Q[N].

Bad pixel correction unit 64I includes BPC cold pixels detector 100 and BPC hot pixels detector 110. BPC cold pixels detector 100 determines if the center pixel within a particular window of the raw data (e.g., a 5×5) window is a cold pixel. In general, a cold pixel is a pixel having a much lower component value (e.g., in-phase value for bad pixel correction unit 64I) relative to the other values in the window. Likewise, BPC hot pixels detector 110 determines if the center pixel within a particular window of the raw data (e.g., a 5×5) window is a hot pixel. In general, a hot pixel is a pixel having a much higher component value (e.g., in-phase value for bad pixel correction unit 64I) relative to the other values in the window.

If either BPC cold pixels detector 100 or BPC hot pixels detector 110 determines that the current center pixel of the window being analyzed is a hot pixel or a cold pixel, OR gate 120 returns a positive value. If neither BPC cold pixels detector 100 nor BPC hot pixels detector 110 determines that the current center pixel of the window being analyzed is a hot pixel or a cold pixel, OR gate 120 returns a negative value. The output of OR gate 120 is used to control switch 130.

If either BPC cold pixels detector 100 or BPC hot pixels detector 110 detects a cold/hot pixel, switch 130 passes through the median value I_{MED}[N] corresponding to the center pixel, and that median value is used as the new center pixel value in 5×5 grid 65I. If neither BPC cold pixels detector 100 nor BPC hot pixels detector 110 detects a cold/hot pixel, switch 130 passes through the original center value of the pixel to be used in 5×5 grid 65I. Bad pixel correction unit 64Q perform an identical process on quadrature values Q[N] for updating 5×5 grid 65Q, which contains quadrature values.

5×5 grid 65I and 65Q are used by thresholding unit 66 and joint bilateral filter to perform spatial denoising. The spatial denoising process will be described in more detail below. Note that the new center pixel produced by bad pixel correction unit 64I and 64Q, although possible in some cases, does not actually update the original window values, but may be instead only used for the joint bilateral filtering process. That is, in some examples, even if a bad pixel is detected, that bad pixel value remains in the original (I,Q)[N] data to detect other bad pixels in the next window processed by bad pixel correction unit 64I and 64Q.

Bad pixel correction unit 64I may be able to detect circumstances of a particular pixel sensor of ITOF sensor 13 performing an incorrect detection (e.g., a hot pixel or a cold pixel). In addition to accounting for sensor problems, BPC cold pixels detector 100 and BPC hot pixels detector 110 may detect anomalous component values of ITOF sensor 13 due to shot noise. In general, shot noise may be transient or intermittent noise that may occur in a particular frame captured by ITOF sensor 13.

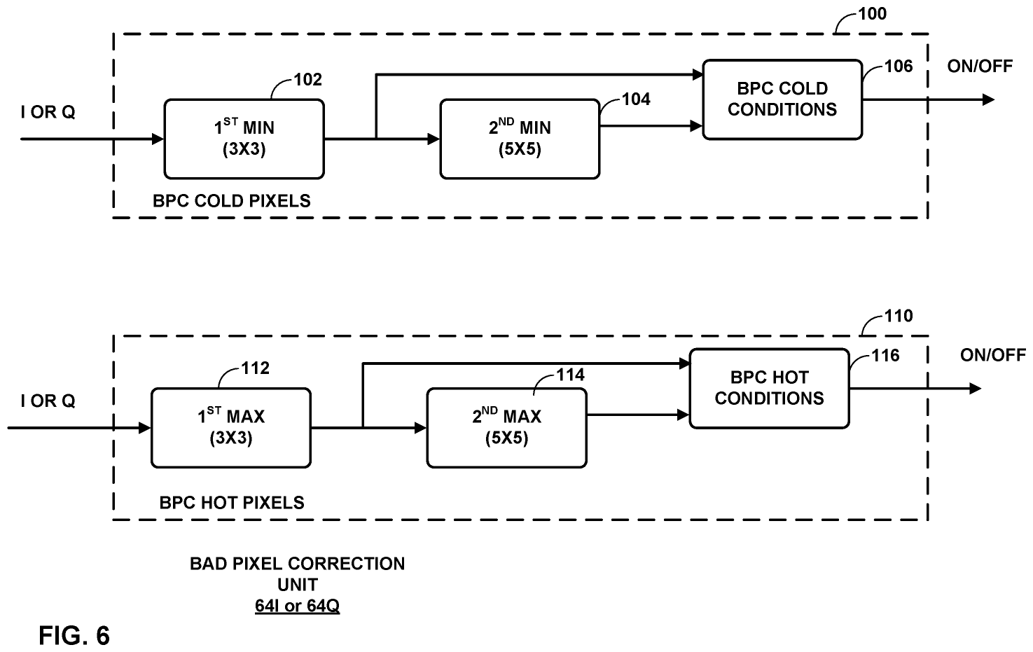

FIG. 6 is a conceptual diagram showing one example of bad pixel correction unit 64I or 64Q. BPC cold pixels detector 100 receives an input of a 5×5 grid of I or Q values around a center pixel. A 1^{st} MIN function 102 determines the minimum in-phase or quadrature component value in a 3×3 grid immediately surrounding the center pixel value. Then, 2^{nd} MIN function 104 expands the search area around the pixel that has the minimum value detected by the 1^{st} MIN function 102 to determine the pixel with the minimum value in that expanded search area. Then, BPC cold conditions unit 106 compares that second minimum value to the center pixel value. If the center pixel value is lower than the second minimum value by some predetermined threshold, BPC cold conditions unit 106 determines that the center pixel is a cold pixel.

Similarly, BPC hot pixels detector 110 receives the same input of a 5×5 grid of I or Q values around a center pixel. A 1^{st} MAX function 112 determines the maximum in-phase or quadrature component value in a 3×3 grid immediately surrounding the center pixel value. Then, 2^{nd} MAX function 114 expands the search area around the pixel that has the maximum value detected by the 1^{st} MAX function 112 to determine the pixel with the maximum value in that expanded search area. Then, BPC hot conditions unit 116 compares that second maximum value to the center pixel value. If the center pixel value is higher than the second maximum value by some predetermined threshold, BPC hot conditions unit 116 determines that the center pixel is a hot pixel.

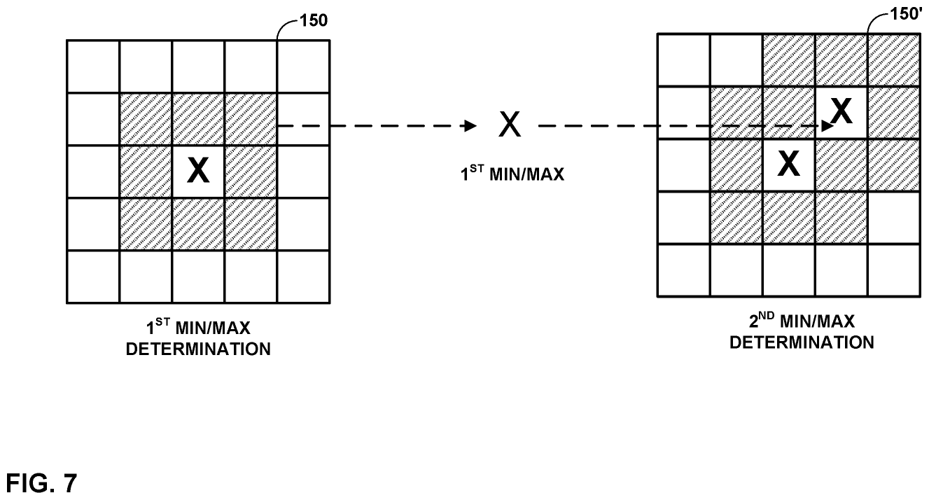

FIG. 7 is a conceptual diagram showing one example cold pixel and hot pixel determination according to the techniques of this disclosure. BPC cold pixels detector 100 and BPC hot pixels detector 110 may use a 5×5 window 150 of component values surrounding a current center pixel. BPC cold pixels detector 100 first finds a first minimum component value (in-phase or quadrature) from the eight component values (with hash marks) surrounding the center pixel X in window 150. Then, based on the first minimum component value, BPC cold pixels detector 100 expands the search as shown in window 150′. That is, BPC cold pixels detector 100 expands the search to include both the original 8 component values surrounding the center pixel as well as the 8 component values surrounding the first minimum value, excluding the original center component value and the first minimum component value. Using the expanded search area in window 150′, BPC cold pixels detector 100 determines the second minimum component value.

Similarly, BPC hot pixels detector 110 use a 5×5 window 150 of component values surrounding a current center pixel. BPC hot pixels detector 110 first finds a first maximum component value (in-phase or quadrature) from the eight component values (with hash marks) surrounding the center pixel X in window 150. Then, based on the first maximum component value, BPC hot pixels detector 110 expands the search as shown in window 150′. That is, BPC hot pixels detector 110 expands the search to include both the original 8 component values surrounding the center pixel as well as the 8 component values surrounding the first maximum value, excluding the original center component value and the first maximum component value. Using the expanded search area in window 150′, BPC hot pixels detector 110 determines the second maximum component value.

Returning to FIG. 4, joint spatial noise reduction filter 60 may then perform joint bilateral filtering on the window 65I (e.g., a 5×5 window) of in-phase component values and the window 65Q (e.g., a 5×5 window) of quadrature component values jointly. In the example of FIG. 4, windows 65I and 65Q have been pre-processed to replace hot and cold pixels, as well as pixels having shot noise, as described above. However, in other examples, bad pixel correction unit 64I and 64Q may be skipped. Also, thresholding unit 66 and joint bilateral filter 68 may be configured to operate on different window sizes, include 3×3 windows and windows larger than 5×5.

In the context of this disclosure, joint bilateral filtering may include determining filter weights and strengths for joint bilateral filter 68 based on both in-phase and quadrature components together. The determined weights and strengths are then applied to each of the components equally. Because each of the in-phase components and quadrature components are filtered using the same strengths and weights, the relationships between the in-phase and quadrature components for each pixel in the current frame are maintained, thus increasing the accuracy of depth calculations made from the filtered raw data.

Joint bilateral filter 68 may be configured as a smoothing filter that smooths the spatial noise in the in-phase and quadrature components of the current frame. Thresholding unit 66 may calculate differences between surrounding pixels and the center pixel in windows 65I and 65Q to determine weights for joint bilateral filter 68. For example, thresholding unit 66 may first calculate a difference between a center pixel C and neighbor pixels (i^{th} pixel within the 5×5 window 65I and 65Q, i∈W_{5×5}). Thresholding unit 66 calculates an average, diff[i], of two difference values for the in-phase and quadrature components using one of the following equations:

$$diff [ i ] = max ( ‖ I [ i ] - I [ C ] ‖ , ‖ Q [ i ] - Q [ C ] ‖ ) ,$$

$$or$$

$$weighted average of$$

$$‖ I [ i ] - I [ C ] ‖ ,$$

$$‖ Q [ i ] - Q [ C ] ‖ ,$$

$$or$$

$$\vert sqrt ( I [ i ] \hat{} 2 + Q [ i ] \hat{} 2 ) - sqrt ( I [ C ] \hat{} 2 + Q [ C ] \hat{} 2 ) \vert .$$

In the above, I[i] is the value of a neighboring in-phase component of window 65I. I[C] is the value of the center in-phase component in window 65I. Q[i] is the value of a neighboring quadrature component of window 65Q. Q[C] is the value of the center quadrature component in window 65Q. The function max returns the maximum of the two differences. The function weighted average performs a weighted average of the two differences. The function sqrt performs a square root.

Thresholding unit 66 may linearly adjust the value of diff[i] based on two thresholding values, thr1, thr2, and a noise standard deviation (σ). Based on the values of diff[i], thr1, thr2, and σ, thresholding unit 66 may determine a weight that joint bilateral filter 68 may apply to windows 65I and 65Q, as shown below:

$$weight [ i ] = 256 \times ( 1 - \frac{diff [ i ] - thr 1 \cdot σ}{thr 2 \cdot σ - thr 1 \cdot σ} )$$

The thresholds thr1 and thr2 are tuning parameters. The value of thr1 and thr2 may be determined based on the on the desired denoise strength. The value of thr1 sets a tolerable low difference (diff) level, while the value of thr2 sets the un-tolerable difference (diff) level.

In some examples, the above equation can be simplified, as shown below with precalculated parameters (K₁ and K₂) and a precalculated inverse noise standard deviation lookup table (LUT).

$$weight [ i ] = 256 \times ( \frac{thr 2}{thr 2 - thr 1} ) - 256 \times ( \frac{1}{thr 2 - thr 1} ) \times \frac{diff [ i ]}{σ} = {K}_{2} - {K}_{1} \times \frac{diff [ i ]}{σ} ,$$

$$where$$

$${K}_{1} = \frac{256}{thr 2 - thr 1}$$

$$and$$

$${K}_{2} = \frac{256 \times thr 2}{thr 2 - thr 1}$$

Joint bilateral filter 68 calculates a weighted sum of the following values:

$${I}_{filtered} = \frac{sum\_I}{sum\_weight} ,$$

$$where$$

$$sum\_I = {\sum }_{i ∈ {W}_{5 \times 5}} I [ i ] \times weight [ i ]$$

$${Q}_{filtered} = \frac{sum\_Q}{sum\_weight} ,$$

$$where$$

$$sum\_Q = {\sum }_{i ∈ {W}_{5 \times 5}} Q [ i ] \times weight [ i ]$$

$$sum\_weight = {\sum }_{i ∈ {W}_{5 \times 5}} weight [ i ]$$

Joint bilateral filter 68 calculates a final output (I_{NR},Q_{NR})[N] for the current frame using the following weighted sum:

$${I}_{NR} = {w}_{1} \times I [ C ] + {w}_{2} \times {I}_{filtered} .$$

$${Q}_{NR} = {w}_{1} \times Q [ C ] + {w}_{2} \times {Q}_{filtered} .$$

This process can be rewritten as below:

$${LP}_{{value}_{I}} = \frac{sum\_I}{sum\_weight} ,$$

$$where$$

$$sum\_I = {\sum }_{i ∈ {W}_{5 \times 5}} ( I [ i ] - I [ C ] ) \times weight [ i ]$$

$${LP}_{{value}_{Q}} = \frac{sum\_Q}{sum\_weight} ,$$

$$where$$

$$sum\_Q = {\sum }_{i ∈ {W}_{5 \times 5}} ( Q [ i ] - Q [ C ] ) \times weight [ i ]$$

$$sum\_weight = {\sum }_{i ∈ {W}_{5 \times 5}} weight [ i ]$$

The noise reduced outputs of joint bilateral filter 68 are:

$${I}_{NR} = I [ C ] + W \times {LP}_{{value}_{I}}$$

$${Q}_{NR} = Q [ C ] + W \times {LP}_{{value}_{Q}}$$

In the equations above, W is a blending weight for blending the original pixel value with the filtered value. The higher the value of W, the more strength of the noise reduction.

As shown in FIG. 4, joint spatial noise reduction filter 60 may further include an optional adjustment filter 69. Adjustment filter 69 may provide for additional smoothing based on the median value produced by median filter 62. If enabled, adjustment filter may average the component values output by joint bilateral filter 68 ((I_{NR},Q_{NR})[N]) with corresponding median values produced by median filter 62 ((I_{MED},Q_{MED})[N]).

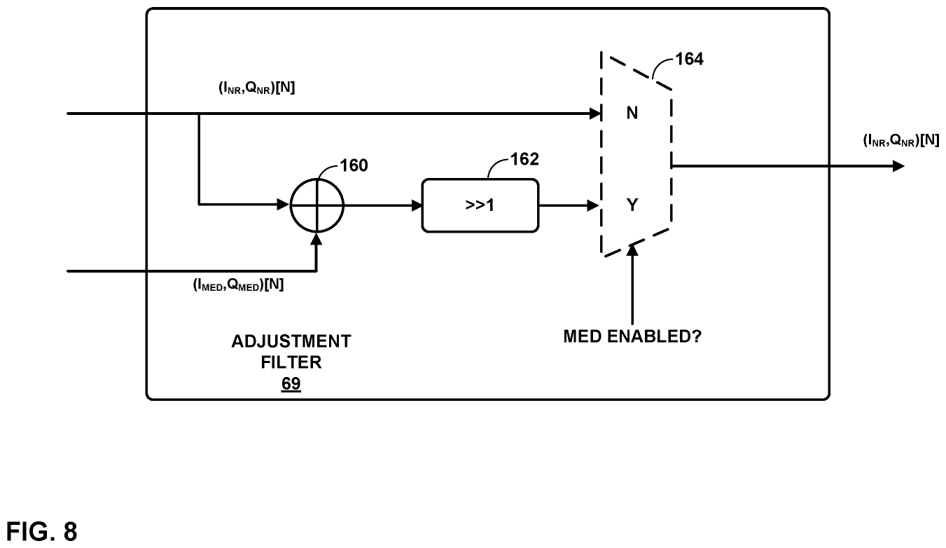

FIG. 8 is a block diagram showing one example of an adjustment process performed by adjustment filter 69 according to the techniques of this disclosure. Adjustment filter receives the output of joint bilateral filter 68 ((I_{NR},Q_{NR})[N]) and median filter 62 ((I_{MED},Q_{MED})[N]). If further median filter is enabled (MED enabled?=yes), then adjustment filter 69 outputs the average of corresponding component values in (I_{NR}, Q_{NR})[N] and I_{MED},Q_{MED})[N]. As shown in FIG. 8, adder 160 adds together corresponding component values in (I_{NR},Q_{NR})[N] and I_{MED},Q_{MED})[N]. Divider 162 then divides the added values by two. Divider 162 is shown as performing a bitwise right shift by 1 (>>1), which is equivalent to divided by 2. Switch 164 then passes through the average value as the new value of (I_{NR},Q_{NR})[N]. If additional median filtering is not enabled, (MED enabled?=no), then adjustment filter 69 outputs (I_{NR},Q_{NR})[N] from joint bilateral filter 68 unchanged.

Returning to FIG. 3, after the spatial noise reduction performed by joint spatial noise reduction filter 60, temporal filter 70 of joint noise reduction unit 40 may then perform joint temporal filtering on the output of joint bilateral filter 68 ((I_{NR},Q_{NR})[N]). In general, temporal filter 70 is configured to apply temporal filtering while also avoiding the introduction of motion artifacts. In some examples, temporal filter 70 may be an infinite impulse response (IIR) temporal filter.

Temporal filter may include motion estimation unit 72 and motion blending unit 74. In general, motion estimation unit 72 compares the values of the noise reduced current frame (I_{NR},Q_{NR})[N] with accumulated values of one or more previously temporally filtered frames (I_{TF},Q_{TF})[Prev]. After each process by motion blending unit 74, the information for (I_{TF},Q_{TF})[N] is stored as (I_{TF},Q_{TF})[Prev]. In this way, the new value of (I_{TF},Q_{TF})[Prev] has accumulated all previous frames until frame N. Motion estimation unit 72 determines a motion map, which generally indicates the amount of motion detected between in-phase and quadrature components of the spatial noise reduced frame ((I_{NR},Q_{NR})[N]) and the accumulated previous temporally filtered frames (I_{TF},Q_{TF})[Prev]. As with the spatial denoising, motion estimation unit 72 determines the motion map using both the in-phase and quadrature components jointly. That is, the determination of motion is based on both the in-phase and quadrature components. As such, the decision to perform motion blending by motion blending unit 74 is the same for both in-phase and quadrature components.

Motion blending unit 74 may use this motion map to determine the amount of blending to be performed between the in-phase and quadrature components of the spatial noise reduced frame ((I_{NR},Q_{NR})[N]) and the in-phase and quadrature components of the accumulated previous temporally filtered frames (I_{TF},Q_{TF})[Prev]. A high level of motion may result in little to no blending, while a low level of motion may result in more blending. By first measuring the motion with motion estimation unit 72, motion artifacts can be avoided in situations where there is a large amount of motion detected between frames. However, if little to no motion is detected, temporal frames may be blended to achieve further smoothing and denoising. The output of temporal filter is (I_{TF},Q_{TF})[N].

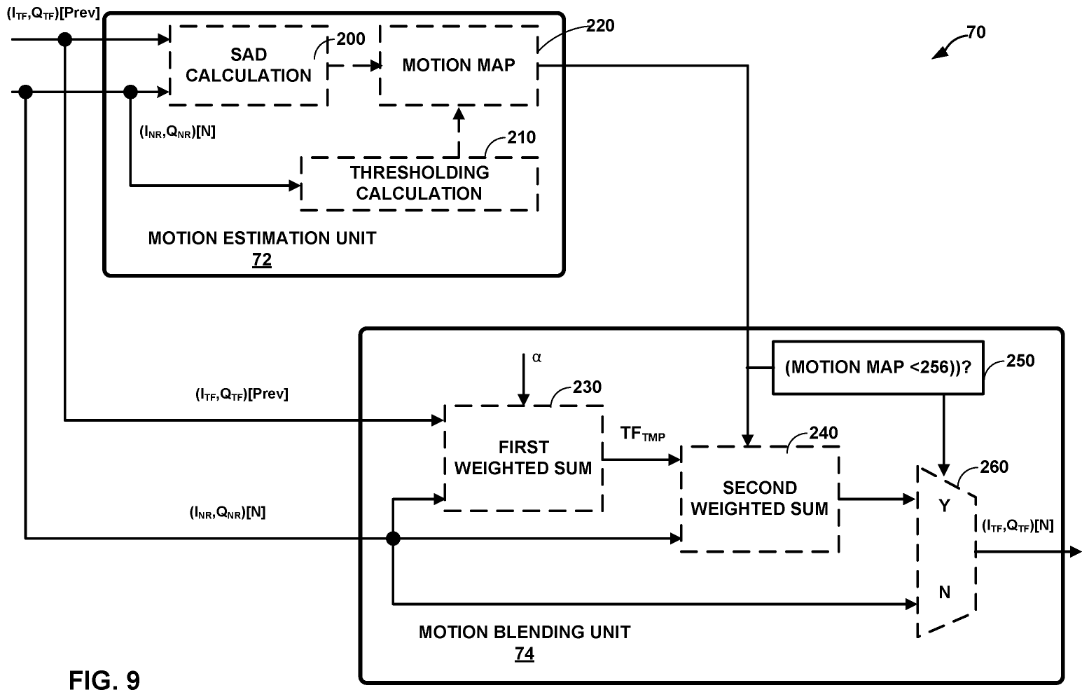

FIG. 9 is a block diagram showing one example of temporal filter 70 in more detail. Motion estimation unit 72 includes an sum of absolute differences (SAD) calculation unit 200, a thresholding calculation unit 210. SAD calculation unit 200 and thresholding calculation unit 210 are used to produce motion map 220.

In generation, motion estimation unit 72 compares component values (e.g., both in-phase and quadrature) in the current frame (I_{NR},Q_{NR})[N]) and with accumulated component values for one or more previous frames (I_{TF},Q_{TF})[Prev]. For example, SAD calculation unit 200 may calculate a SAD between respective component values in the current frame ((I_{NR},Q_{NR})[N]) and with respective accumulated component values for one or more previous frames (I_{TF},Q_{TF})[Prev].

If there is a large difference (e.g., as compared to a threshold) within a fixed window (e.g., a 5×5 window), such a difference indicates motion between the frames. SAD calculation unit 200 operates on both in-phase and quadrature frames and takes into consideration both differences. For example, SAD calculation unit 200 may take any large value of the two differences shown below:

$$max ( \vert {I}_{NR} [ n ] [ i ] - {I}_{TF} [ Prev ] [ i ] \vert , \vert {Q}_{NR} [ n ] [ i ] - {Q}_{TF} [ Prev ] [ i ] \vert ) ,$$

$$or weighted average of difference ,$$

$$\vert {I}_{NR} [ n ] [ i ] - {I}_{TF} [ Prev ] [ i ] \vert ,$$

$$\vert {Q}_{NR} [ n ] [ i ] - {Q}_{TF} [ Prev ] [ i ] \vert ,$$

$$or$$

$$sqrt ( {{I}_{NR} [ n ] [ i ]}^{2} + {{Q}_{NR} [ n ] [ i ]}^{2} ) - sqrt ( {{I}_{TF} [ Prev ] [ i ]}^{2} + {{Q}_{TF} [ Prev ] [ i ]}^{2} )$$

Described another way, the output of SAD calculation unit is:

$${SAD}_{value} = {\sum }_{i ∈ {W}_{5 \times 5}} max ( \vert {I}_{NR} [ i ] - {I}_{TF} [ i ] \vert , \vert {Q}_{NR} [ i ] ‐ {Q}_{TF} [ i ] \vert )$$

The SADᵥₐₗᵤₑ calculated by SAD calculation unit 200 may be linearly adjusted to a set range of values (e.g., 0 to 256) based on two thresholding values, m1 and m2, determined by thresholding calculation unit 210. The thresholding values m1 and m2 may be calculated in a similar fashion to that of thresholding unit 66. If the SADᵥₐₗᵤₑ is less than m1, the SADᵥₐₗᵤₑ maps to zero in motion map 220. If the SADᵥₐₗᵤₑ is more than m2, the SADᵥₐₗᵤₑ maps to 256 in motion map 220. If the SADᵥₐₗᵤₑ is between m1 and m2, the SADᵥₐₗᵤₑ will be mapped linearly to 0 to 256. The final output value is a motion value in motion map 220 in a range of 0 to 256. Of course, other ranges could be used.

Motion blending unit 74 may use the calculated motion value in motion map 220 as a weight value in motion blending. Motion blending unit 74 may include a first weighted sum unit 230 and a second weighted sum unit 240. First weighted sum unit 230 may be configured to blend respective component values in (I_{NR},Q_{NR})[N] and (I_{TF},Q_{TF})[Prev] using configurable weight α. The output of first weighted sum unit 230 of TF_{TMP}. In one example, first weighted sum unit 230 calculates TF_{TMP} for in-phase components as:

$${TF}_{tmp} = ( 1 - {w}_{α} ) \times {I}_{TF} [ Prev ] + {w}_{α} \times {I}_{NR} [ N ] = ( ( {I}_{TF} [ Prev ] ≪ 8 ) + α \times ( {I}_{NR} [ N ] - {I}_{TF} [ Prev ] ) ) ≫ 8$$

The same process is applied to quadrature components.

Second weighted sum unit 240 may then calculate a weighted sum for the components of TF_{TMP} and (I_{NR}, Q_{NR})[N] using the corresponding motion value in motion map 220 as the weight. The output of second weighted sum unit 240 is (ITF,QTF)[N]. Second weighted sum unit 240 may calculate ITF[N] as:

$${I}_{TF} [ N ] = ( 1 - {w}_{m} ) \times {TF}_{tmp} + {w}_{m} \times {I}_{NR} [ N ] = ( ( {TF}_{tmp} ≪ 8 ) + motion\_value \times ( {I}_{NR} [ N ] - {TF}_{tmp} ) ) ≫ 8$$

The same process is applied to quadrature components.

Switch 260 determines what value is output as (I_{TF},Q_{TF})[N]: either (I_{NR},Q_{NR})[N]) without any temporal blending, or the blended output of second weighted sum unit 240 described above. Switch 260 makes this determination based on motion map comparator 250. If the motion value in motion map 220 is less than 256 (e.g., indicating a relatively low amount of motion), motion map comparator 250 outputs a 1 (e.g., a Yes (Y)), and the output of second weighted sum unit 240 is passed. If the motion value in motion map 220 is not less than 256 (e.g., indicating a relatively high amount of motion), motion map comparator 250 outputs a 0 (e.g., a No (N)), and the original value of (I_{NR},Q_{NR})[N]) is passed as (I_{TF},Q_{TF})[N] without temporal blending. In this way, motion artifacts are avoided.

Returning to FIG. 3, after temporal filtering, joint noise reduction unit 40 may apply a second round of spatial filtering using joint spatial noise reduction filter 80. Joint spatial noise reduction filter 80 may be configured to operate in the same manner as joint spatial noise reduction filter 60. However, joint spatial noise reduction filter 80 takes the temporally filtered output (I_{TF},Q_{TF})[N] as input. The output of joint spatial noise reduction filter 80 is a filtered output frame (I_{OUT},Q_{OUT})[N], which may then be used to perform depth and/or distance calculations.

In examples where the raw data from ITOF sensor 13 is companded, joint noise reduction unit 40 may further include a data decompanding unit 90. Data decompanding unit 90 applies a piecewise linear function to (I_{OUT},Q_{OUT})[N] that is the inverse of the companding that was applied by ITOF sensor 13. In this way, (T_{OUT},Q_{OUT})[N] is converted back to a linear domain, at a higher bit depth, for more accurate depth and distance calculations.

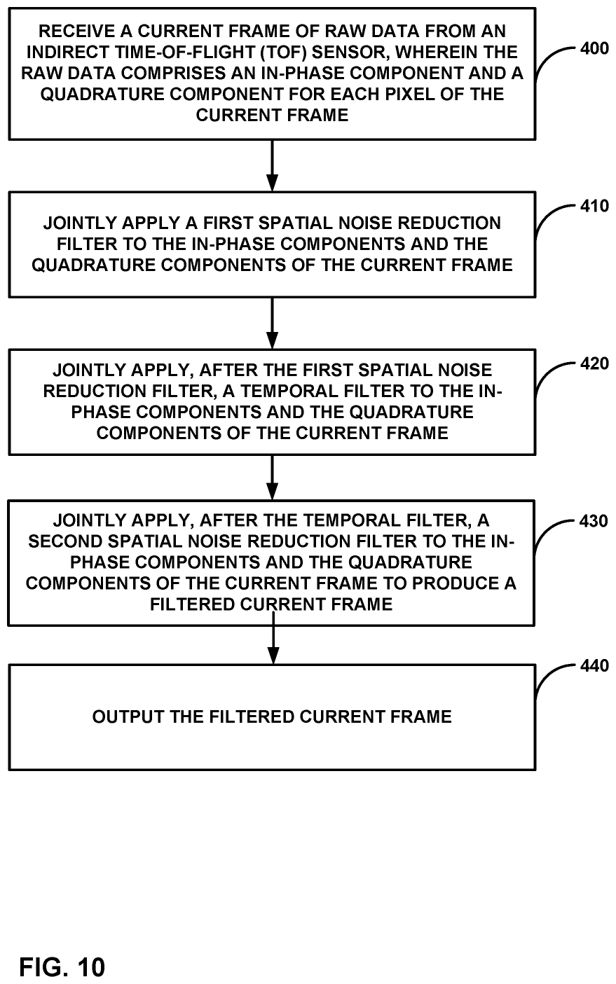

FIG. 10 is a flowchart showing an example method of operation according to the techniques of this disclosure. The techniques of FIG. 10 may be performed by joint noise reduction unit 40.

In one example, joint noise reduction unit 40 may be configured to receive a current frame of raw data from an indirect time-of-flight (ToF) sensor, wherein the raw data comprises an in-phase component and a quadrature component for each pixel of the current frame (400). Joint noise reduction unit 40 may jointly apply a first spatial noise reduction filter to the in-phase components and the quadrature components of the current frame (410). Joint noise reduction unit 40 may then jointly apply, after the first spatial noise reduction filter, a temporal filter to the in-phase components and the quadrature components of the current frame (420). In one example, the temporal filter is an infinite impulse response temporal filter that uses the in-phase components and the quadrature components of the current frame and accumulated temporally filtered raw data from one or more previous frames as inputs. Joint noise reduction unit 40 may further jointly apply, after the temporal filter, a second spatial noise reduction filter to the in-phase components and the quadrature components of the current frame to produce a filtered current frame (430). Joint noise reduction unit 40 may then output the filtered current frame (440). A processing device, such as processing device 10 of FIG. 1, may then determine depth values from the filtered current frame.

In one example, the current frame of raw data is companded. In this example, joint noise reduction unit 40 may be further configured to decompand the filtered current frame prior to outputting the filtered current frame.

In one example, to jointly apply the first spatial noise reduction filter to the in-phase components and the quadrature components of the current frame, joint noise reduction unit 40 is configured to perform bad pixel correction to both the in-phase components and the quadrature components of the current frame, and apply, after the bad pixel correction, a first joint bilateral filter to the in-phase components and the quadrature components of the current frame. In a further example, to perform the bad pixel correction to both the in-phase components and the quadrature components of the current frame, joint noise reduction unit 40 is configured to determine a median value for the in-phase component or the quadrature component using neighboring in-phase component values or quadrature component values around a center pixel, determine if the center pixel is a hot pixel or a cold pixel, and use the median value for the in-phase component or the quadrature component as a new center pixel value based on the center pixel being the hot pixel or the cold pixel.

In one example, to jointly apply, after the first spatial noise reduction filter, the temporal filter to the in-phase components and the quadrature components of the current frame, joint noise reduction unit 40 is configured to perform joint motion estimation on the in-phase components and the quadrature components of the current frame using accumulated temporally filtered raw data from one or more previous frames, and perform motion blending, based on the joint motion estimation. In a further example, to perform motion blending, joint noise reduction unit 40 is configured to perform one or more weighted sums of the in-phase components and the quadrature components of the current frame and the accumulated temporally filtered raw data from the one or more previous frames based on the joint motion estimation being below a threshold.

In another example, to jointly apply the second spatial noise reduction filter to the in-phase components and the quadrature components of the current frame, joint noise reduction unit 40 is configured to apply a second joint bilateral filter to the in-phase components and the quadrature components of the current frame.

In another example, joint noise reduction unit 40 is configured to determine median values for the in-phase components and the quadrature components of the current frame using neighboring in-phase component values or quadrature component values around a center pixel, and average, after the second spatial noise reduction filter, the in-phase components and the quadrature components of the filtered current frame with corresponding median values for the in-phase component and the quadrature component.

The following describes other example aspects of the disclosure. The techniques of the following aspects may be used separately or in any combination.

Aspect 1—An apparatus configured for sensor processing, the apparatus comprising: a memory; and one or more processors coupled to the memory, the one or more processors configured to cause the apparatus to: receive a current frame of raw data from an indirect time-of-flight (ToF) sensor, wherein the raw data comprises an in-phase component and a quadrature component for each pixel of the current frame; jointly apply a first spatial noise reduction filter to the in-phase components and the quadrature components of the current frame; jointly apply, after the first spatial noise reduction filter, a temporal filter to the in-phase components and the quadrature components of the current frame; jointly apply, after the temporal filter, a second spatial noise reduction filter to the in-phase components and the quadrature components of the current frame to produce a filtered current frame; and output the filtered current frame.

Aspect 2—The apparatus of Aspect 1, wherein the current frame of raw data is companded, and wherein the one or more processors are further configured to cause the apparatus to: decompand the filtered current frame prior to outputting the filtered current frame.

Aspect 3—The apparatus of any of Aspects 1-2, wherein to jointly apply the first spatial noise reduction filter to the in-phase components and the quadrature components of the current frame, the one or more processors are further configured to cause the apparatus to: perform bad pixel correction to both the in-phase components and the quadrature components of the current frame; and apply, after the bad pixel correction, a first joint bilateral filter to the in-phase components and the quadrature components of the current frame.

Aspect 4—The apparatus of Aspect 3, wherein to perform the bad pixel correction to both the in-phase components and the quadrature components of the current frame, the one or more processors are further configured to cause the apparatus to: determine a median value for the in-phase component or the quadrature component using neighboring in-phase component values or quadrature component values around a center pixel; determine if the center pixel is a hot pixel or a cold pixel; and use the median value for the in-phase component or the quadrature component as a new center pixel value based on the center pixel being the hot pixel or the cold pixel.

Aspect 5—The apparatus of any of Aspects 1-4, wherein the temporal filter is an infinite impulse response temporal filter that uses the in-phase components and the quadrature components of the current frame and accumulated temporally filtered raw data from one or more previous frames as inputs.

Aspect 6—The apparatus of any of Aspects 1-5, wherein to jointly apply, after the first spatial noise reduction filter, the temporal filter to the in-phase components and the quadrature components of the current frame, the one or more processors are further configured to cause the apparatus to: perform joint motion estimation on the in-phase components and the quadrature components of the current frame using accumulated temporally filtered raw data from one or more previous frames; and perform motion blending, based on the joint motion estimation.

Aspect 7—The apparatus of Aspect 6, wherein to perform motion blending, the one or more processors are further configured to cause the apparatus to: perform one or more weighted sums of the in-phase components and the quadrature components of the current frame and the accumulated temporally filtered raw data from the one or more previous frames based on the joint motion estimation being below a threshold.

Aspect 8—The apparatus of any of Aspects 1-7, wherein to jointly apply the second spatial noise reduction filter to the in-phase components and the quadrature components of the current frame, the one or more processors are further configured to cause the apparatus to: apply a second joint bilateral filter to the in-phase components and the quadrature components of the current frame.

Aspect 9—The apparatus of any of Aspects 1-8, wherein the one or more processors are further configured to cause the apparatus to: determine median values for the in-phase components and the quadrature components of the current frame using neighboring in-phase component values or quadrature component values around a center pixel; and average, after the second spatial noise reduction filter, the in-phase components and the quadrature components of the filtered current frame with corresponding median values for the in-phase component and the quadrature component.

Aspect 10—The apparatus of any of Aspects 1-9, wherein the one or more processors are further configured to cause the apparatus to: determine depth values from the filtered current frame.

Aspect 11—The apparatus of any of Aspects 1-10, further comprising: the indirect ToF sensor.

Aspect 12—A method for sensor processing, the method comprising: receiving a current frame of raw data from an indirect time-of-flight (ToF) sensor, wherein the raw data comprises an in-phase component and a quadrature component for each pixel of the current frame; jointly applying a first spatial noise reduction filter to the in-phase components and the quadrature components of the current frame; jointly applying, after the first spatial noise reduction filter, a temporal filter to the in-phase components and the quadrature components of the current frame; jointly applying, after the temporal filter, a second spatial noise reduction filter to the in-phase components and the quadrature components of the current frame to produce a filtered current frame; and outputting the filtered current frame.

Aspect 13—The method of Aspect 12, wherein the current frame of raw data is companded, the method further comprising: decompanding the filtered current frame prior to outputting the filtered current frame.

Aspect 14—The method of any of Aspects 12-13, wherein jointly applying the first spatial noise reduction filter to the in-phase components and the quadrature components of the current frame comprises: performing bad pixel correction to both the in-phase components and the quadrature components of the current frame; and applying. after the bad pixel correction, a first joint bilateral filter to the in-phase components and the quadrature components of the current frame.

Aspect 15—The method of Aspect 14, wherein performing the bad pixel correction to both the in-phase components and the quadrature components of the current frame comprises: determining a median value for the in-phase component or the quadrature component using neighboring in-phase component values or quadrature component values around a center pixel; determining if the center pixel is a hot pixel or a cold pixel; and using the median value for the in-phase component or the quadrature component as a new center pixel value based on the center pixel being the hot pixel or the cold pixel.

Aspect 16—The method of any of Aspects 12-15, wherein the temporal filter is an infinite impulse response temporal filter that uses the in-phase components and the quadrature components of the current frame and accumulated temporally filtered raw data from one or more previous frames as inputs.

Aspect 17—The method of any of Aspects 12-16, wherein jointly applying, after the first spatial noise reduction filter, the temporal filter to the in-phase components and the quadrature components of the current frame comprises: performing joint motion estimation on the in-phase components and the quadrature components of the current frame using accumulated temporally filtered raw data from one or more previous frames; and performing motion blending, based on the joint motion estimation.

Aspect 18—The method of Aspect 17, wherein performing motion blending comprises: performing one or more weighted sums of the in-phase components and the quadrature components of the current frame and the accumulated temporally filtered raw data from the one or more previous frames based on the joint motion estimation being below a threshold.

Aspect 19—The method of any of Aspects 12-18, wherein jointly applying the second spatial noise reduction filter to the in-phase components and the quadrature components of the current frame comprises: applying a second joint bilateral filter to the in-phase components and the quadrature components of the current frame.

Aspect 20—The method of any of Aspects 12-19, further comprising: determining median values for the in-phase components and the quadrature components of the current frame using neighboring in-phase component values or quadrature component values around a center pixel; and averaging, after the second spatial noise reduction filter, the in-phase components and the quadrature components of the filtered current frame with corresponding median values for the in-phase component and the quadrature component.

Aspect 21—The method of any of Aspects 12-20, further comprising: determining depth values from the filtered current frame.

Aspect 22—The method of any of Aspects 12-21, further comprising: capturing the current frame of raw data with the indirect ToF sensor.

Aspect 23—A non-transitory computer-readable storage medium storing instructions that, when executed, cause one or more processors to: receive a current frame of raw data from an indirect time-of-flight (ToF) sensor, wherein the raw data comprises an in-phase component and a quadrature component for each pixel of the current frame; jointly apply a first spatial noise reduction filter to the in-phase components and the quadrature components of the current frame; jointly apply, after the first spatial noise reduction filter, a temporal filter to the in-phase components and the quadrature components of the current frame; jointly apply, after the temporal filter, a second spatial noise reduction filter to the in-phase components and the quadrature components of the current frame to produce a filtered current frame; and output the filtered current frame.

Aspect 24—The non-transitory computer-readable storage medium of Aspect 23, wherein the current frame of raw data is companded, and wherein instructions further cause the one or more processors to: decompand the filtered current frame prior to outputting the filtered current frame.

Aspect 25—The non-transitory computer-readable storage medium of any of Aspects 23-24, wherein to jointly apply the first spatial noise reduction filter to the in-phase components and the quadrature components of the current frame, the instructions further cause the one or more processors to: perform bad pixel correction to both the in-phase components and the quadrature components of the current frame; and apply, after the bad pixel correction, a first joint bilateral filter to the in-phase components and the quadrature components of the current frame.

Aspect 26—The non-transitory computer-readable storage medium of any of Aspects 23-25, wherein to jointly apply, after the first spatial noise reduction filter, the temporal filter to the in-phase components and the quadrature components of the current frame, the instructions further cause the one or more processors: perform joint motion estimation on the in-phase components and the quadrature components of the current frame using accumulated temporally filtered raw data from one or more previous frames; and perform motion blending, based on the joint motion estimation.

Aspect 27—An apparatus configured for sensor processing, the apparatus comprising: means for receiving a current frame of raw data from an indirect time-of-flight (ToF) sensor, wherein the raw data comprises an in-phase component and a quadrature component for each pixel of the current frame; means for jointly applying a first spatial noise reduction filter to the in-phase components and the quadrature components of the current frame; means for jointly applying, after the first spatial noise reduction filter, a temporal filter to the in-phase components and the quadrature components of the current frame; means for jointly applying, after the temporal filter, a second spatial noise reduction filter to the in-phase components and the quadrature components of the current frame to produce a filtered current frame; and means for outputting the filtered current frame.

Aspect 28—The apparatus of Aspect 27, wherein the current frame of raw data is companded, the apparatus further comprising: means for decompanding the filtered current frame prior to outputting the filtered current frame.

Aspect 29—The apparatus of any of Aspects 27-28, wherein the means for jointly applying the first spatial noise reduction filter to the in-phase components and the quadrature components of the current frame comprises: means for performing bad pixel correction to both the in-phase components and the quadrature components of the current frame; and means for applying, after the bad pixel correction, a first joint bilateral filter to the in-phase components and the quadrature components of the current frame.

Aspect 30—The apparatus of any of Aspects 27-29, wherein the means for jointly applying, after the first spatial noise reduction filter, the temporal filter to the in-phase components and the quadrature components of the current frame comprises: means for performing joint motion estimation on the in-phase components and the quadrature components of the current frame using accumulated temporally filtered raw data from one or more previous frames; and means for performing motion blending. based on the joint motion estimation.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus configured for sensor processing, the apparatus comprising:
a memory; and
one or more processors coupled to the memory, the one or more processors configured to cause the apparatus to:
receive a current frame of raw data from an indirect time-of-flight (ToF) sensor, wherein the raw data comprises an in-phase component and a quadrature component for each pixel of the current frame;
jointly apply a first spatial noise reduction filter to the in-phase components and the quadrature components of the current frame;
jointly apply, after the first spatial noise reduction filter, a temporal filter to the in-phase components and the quadrature components of the current frame;
jointly apply, after the temporal filter, a second spatial noise reduction filter to the in-phase components and the quadrature components of the current frame to produce a filtered current frame; and
output the filtered current frame.

2. The apparatus of claim 1, wherein the current frame of raw data is companded, and wherein the one or more processors are further configured to cause the apparatus to:
decompand the filtered current frame prior to outputting the filtered current frame.

3. The apparatus of claim 1, wherein to jointly apply the first spatial noise reduction filter to the in-phase components and the quadrature components of the current frame, the one or more processors are further configured to cause the apparatus to:
perform bad pixel correction to both the in-phase components and the quadrature components of the current frame; and
apply, after the bad pixel correction, a first joint bilateral filter to the in-phase components and the quadrature components of the current frame.

4. The apparatus of claim 3, wherein to perform the bad pixel correction to both the in-phase components and the quadrature components of the current frame, the one or more processors are further configured to cause the apparatus to:
determine a median value for the in-phase component or the quadrature component using neighboring in-phase component values or quadrature component values around a center pixel;
determine if the center pixel is a hot pixel or a cold pixel; and
use the median value for the in-phase component or the quadrature component as a new center pixel value based on the center pixel being the hot pixel or the cold pixel.

5. The apparatus of claim 1, wherein the temporal filter is an infinite impulse response temporal filter that uses the in-phase components and the quadrature components of the current frame and accumulated temporally filtered raw data from one or more previous frames as inputs.

6. The apparatus of claim 1, wherein to jointly apply, after the first spatial noise reduction filter, the temporal filter to the in-phase components and the quadrature components of the current frame, the one or more processors are further configured to cause the apparatus to:
perform joint motion estimation on the in-phase components and the quadrature components of the current frame using accumulated temporally filtered raw data from one or more previous frames; and
perform motion blending, based on the joint motion estimation.

7. The apparatus of claim 6, wherein to perform motion blending, the one or more processors are further configured to cause the apparatus to:
perform one or more weighted sums of the in-phase components and the quadrature components of the current frame and the accumulated temporally filtered raw data from the one or more previous frames based on the joint motion estimation being below a threshold.

8. The apparatus of claim 1, wherein to jointly apply the second spatial noise reduction filter to the in-phase components and the quadrature components of the current frame, the one or more processors are further configured to cause the apparatus to:
apply a second joint bilateral filter to the in-phase components and the quadrature components of the current frame.

9. The apparatus of claim 1, wherein the one or more processors are further configured to cause the apparatus to:
determine median values for the in-phase components and the quadrature components of the current frame using neighboring in-phase component values or quadrature component values around a center pixel; and
average, after the second spatial noise reduction filter, the in-phase components and the quadrature components of the filtered current frame with corresponding median values for the in-phase component and the quadrature component.

10. The apparatus of claim 1, wherein the one or more processors are further configured to cause the apparatus to:
determine depth values from the filtered current frame.

11. The apparatus of claim 1, further comprising:
the indirect ToF sensor.

12. A method for sensor processing, the method comprising:
receiving a current frame of raw data from an indirect time-of-flight (ToF) sensor, wherein the raw data comprises an in-phase component and a quadrature component for each pixel of the current frame;
jointly applying a first spatial noise reduction filter to the in-phase components and the quadrature components of the current frame;
jointly applying, after the first spatial noise reduction filter, a temporal filter to the in-phase components and the quadrature components of the current frame;
jointly applying, after the temporal filter, a second spatial noise reduction filter to the in-phase components and the quadrature components of the current frame to produce a filtered current frame; and
outputting the filtered current frame.

13. The method of claim 12, wherein the current frame of raw data is companded, the method further comprising:
decompanding the filtered current frame prior to outputting the filtered current frame.

14. The method of claim 12, wherein jointly applying the first spatial noise reduction filter to the in-phase components and the quadrature components of the current frame comprises:
performing bad pixel correction to both the in-phase components and the quadrature components of the current frame; and
applying, after the bad pixel correction, a first joint bilateral filter to the in-phase components and the quadrature components of the current frame.

15. The method of claim 14, wherein performing the bad pixel correction to both the in-phase components and the quadrature components of the current frame comprises:
determining a median value for the in-phase component or the quadrature component using neighboring in-phase component values or quadrature component values around a center pixel;
determining if the center pixel is a hot pixel or a cold pixel; and
using the median value for the in-phase component or the quadrature component as a new center pixel value based on the center pixel being the hot pixel or the cold pixel.

16. The method of claim 12, wherein the temporal filter is an infinite impulse response temporal filter that uses the in-phase components and the quadrature components of the current frame and accumulated temporally filtered raw data from one or more previous frames as inputs.

17. The method of claim 12, wherein jointly applying, after the first spatial noise reduction filter, the temporal filter to the in-phase components and the quadrature components of the current frame comprises:
performing joint motion estimation on the in-phase components and the quadrature components of the current frame using accumulated temporally filtered raw data from one or more previous frames; and
performing motion blending, based on the joint motion estimation.

18. The method of claim 17, wherein performing motion blending comprises:
performing one or more weighted sums of the in-phase components and the quadrature components of the current frame and the accumulated temporally filtered raw data from the one or more previous frames based on the joint motion estimation being below a threshold.

19. The method of claim 12, wherein jointly applying the second spatial noise reduction filter to the in-phase components and the quadrature components of the current frame comprises:
applying a second joint bilateral filter to the in-phase components and the quadrature components of the current frame.

20. The method of claim 12, further comprising:
determining median values for the in-phase components and the quadrature components of the current frame using neighboring in-phase component values or quadrature component values around a center pixel; and
averaging, after the second spatial noise reduction filter, the in-phase components and the quadrature components of the filtered current frame with corresponding median values for the in-phase component and the quadrature component.

21. The method of claim 12, further comprising:
determining depth values from the filtered current frame.

22. The method of claim 12, further comprising:
capturing the current frame of raw data with the indirect ToF sensor.

23. A non-transitory computer-readable storage medium storing instructions that, when executed, cause one or more processors to:
receive a current frame of raw data from an indirect time-of-flight (ToF) sensor, wherein the raw data comprises an in-phase component and a quadrature component for each pixel of the current frame;
jointly apply a first spatial noise reduction filter to the in-phase components and the quadrature components of the current frame;
jointly apply, after the first spatial noise reduction filter, a temporal filter to the in-phase components and the quadrature components of the current frame;
jointly apply, after the temporal filter, a second spatial noise reduction filter to the in-phase components and the quadrature components of the current frame to produce a filtered current frame; and
output the filtered current frame.

24. The non-transitory computer-readable storage medium of claim 23, wherein the current frame of raw data is companded, and wherein instructions further cause the one or more processors to:
decompand the filtered current frame prior to outputting the filtered current frame.

25. The non-transitory computer-readable storage medium of claim 23, wherein to jointly apply the first spatial noise reduction filter to the in-phase components and the quadrature components of the current frame, the instructions further cause the one or more processors to:
perform bad pixel correction to both the in-phase components and the quadrature components of the current frame; and
apply, after the bad pixel correction, a first joint bilateral filter to the in-phase components and the quadrature components of the current frame.

26. The non-transitory computer-readable storage medium of claim 23, wherein to jointly apply, after the first spatial noise reduction filter, the temporal filter to the in-phase components and the quadrature components of the current frame, the instructions further cause the one or more processors:
perform joint motion estimation on the in-phase components and the quadrature components of the current frame using accumulated temporally filtered raw data from one or more previous frames; and
perform motion blending, based on the joint motion estimation.

27. An apparatus configured for sensor processing, the apparatus comprising:
means for receiving a current frame of raw data from an indirect time-of-flight (ToF) sensor, wherein the raw data comprises an in-phase component and a quadrature component for each pixel of the current frame;
means for jointly applying a first spatial noise reduction filter to the in-phase components and the quadrature components of the current frame;
means for jointly applying, after the first spatial noise reduction filter, a temporal filter to the in-phase components and the quadrature components of the current frame;
means for jointly applying, after the temporal filter, a second spatial noise reduction filter to the in-phase components and the quadrature components of the current frame to produce a filtered current frame; and
means for outputting the filtered current frame.

28. The apparatus of claim 27, wherein the current frame of raw data is companded, the apparatus further comprising:
means for decompanding the filtered current frame prior to outputting the filtered current frame.

29. The apparatus of claim 27, wherein the means for jointly applying the first spatial noise reduction filter to the in-phase components and the quadrature components of the current frame comprises:
means for performing bad pixel correction to both the in-phase components and the quadrature components of the current frame; and
means for applying, after the bad pixel correction, a first joint bilateral filter to the in-phase components and the quadrature components of the current frame.

30. The apparatus of claim 27, wherein the means for jointly applying, after the first spatial noise reduction filter, the temporal filter to the in-phase components and the quadrature components of the current frame comprises:
means for performing joint motion estimation on the in-phase components and the quadrature components of the current frame using accumulated temporally filtered raw data from one or more previous frames; and
means for performing motion blending, based on the joint motion estimation.
